(19) United States
(12) Patent Application Publication
(10) Pub. No.: US 2014/0019335 A1
(43) Pub. Date: Jan. 16, 2014

(54) SYSTEMS AND METHODS FOR SELF-SERVICE CLOUD-BASED ARENAS FOR INFORMATION TECHNOLOGY-DRIVEN SITUATIONAL MANAGEMENT

(71) Applicants: Wilson T. MACDONALD, Holliston, MA (US); Eitan HADAR, Nesher (IL); Steven L. GREENSPAN, Scotch Plains, NJ (US)

(72) Inventors: Wilson T. MACDONALD, Holliston, MA (US); Eitan HADAR, Nesher (IL); Steven L. GREENSPAN, Scotch Plains, NJ (US)

(73) Assignee: CA, INC., Islandia, NY (US)

(21) Appl. No.: 13/547,796

(22) Filed: Jul. 12, 2012

(51) Int. Cl. G06Q 20/26; G06Q 20/28; G06Q 40/00

(52) U.S. Cl. 705/39; 705/35

(57) ABSTRACT

A method includes receiving information from an information provider. The information received from the information provider may comprise metrics collected from a sensor that have been manipulated, meta-data that describes the manipulation, quality information associated with the metrics, and semantic information associated with the metrics. The method includes a process of transforming and correlating the information received from the information provider, such that the information becomes transformed and correlated information. The method includes a process of transmitting the transformed and correlated information to a registered information consumer. The method includes a process of establishing a first account pursuant to the information received from the information provider. The method includes a process of establishing a second account pursuant to the transformed and correlated information transmitted to the registered information consumer. The method includes a process of applying a payment policy based on the first account and the second account.

### BACKGROUND

The present disclosure relates to facilitating the provisioning and consumption of event-based information, and more specifically to providing systems and methods for self-service cloud-based arenas for information technology-driven situational management.

In the domain of cloud computing, the agility and flexibility of the information technology (“IT”) infrastructure, as well as the structure of composite applications are inherited qualities. System structures are changing frequently. For example, systems can mutate, change, and return to the basic structure within a cloud-bursting use case.

These permutations are known as changes in the IT domain. They may create governance, security, and IT management concerns, and trigger automatic or manual notifications to affected parties and systems, and lead to additional changes to data and processes (e.g., Change Management, Problem Management, Project Management).

### BRIEF SUMMARY

According to one aspect of the present disclosure, a method may comprise certain processes for accommodating provisioning and consumption of information. The method may comprise a process of receiving information from an information provider. The information received from the information provider may comprise metrics collected from a sensor that have been manipulated, meta-data that describes the manipulation, quality information associated with the metrics, and semantic information associated with the metrics. The method may comprise a process of transforming and correlating the information received from the information provider, such that the information becomes transformed and correlated information. The method may comprise a process of transmitting the transformed and correlated information to a registered information consumer. The method may comprise a process of establishing a first account pursuant to the information received from the information provider. The method may comprise a process of establishing a second account pursuant to the transformed and correlated information transmitted to the registered information consumer. The method may comprise a process of applying a payment policy based on the first account and the second account.

Other objects, features, and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements.

FIG. 1 illustrates a communication network comprised of public, private, and community clouds.

FIG. 2 illustrates a process executed on a platform for the brokering of situation management awareness implemented as a computer program product.

FIG. 3 illustrates a system for the brokering of situation management awareness.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (e.g., through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

Referring now to facilitating the provisioning and consumption of event-based information, in some cases, events and subsequent changes may be of interest to business owners or analysts interested by the phenomena that caused the change, rather than the change itself. An example of the former (e.g., the change itself) may be requiring a security credential change based on structural changes in the composition of the application. An example of the latter (e.g., the phenomena that caused the change) may be the detection of a theft or fraud, based on a large volume of information technology (“IT”) transactions originating from a certain service or location, within a certain time window.

Existing situational awareness systems may focus on ontology transformation and artificial intelligence to compute and detect the situation within a specific domain. Nevertheless, it may be difficult to predict the situation (s) that the IT systems will need to respond to in an optimal fashion. In addition, businesses may create situation detection algorithms for current IT product portfolios, however, businesses may not know what the next generation of products may comprise or what sensors and monitored data the next generation of products may provide. Accordingly, it may be difficult to predict which products may utilize or which consumers may be interested in such raw or derived event information.

Some businesses may collect data that is valuable to other business and may wish to easily monetize their data collections. In an evolving landscape of inexpensive sensors, communications, and data warehouses, and in a business environment that requires real-time decisions to maintain competitive advantages, businesses (e.g., providers) may need a way to offer new data elements to a coordination system, to enable the construction of a complex situation (e.g., detailed event information regarding particular situations), and to inform other businesses (e.g., consumers) when significant changes are detected.

An example may be a notification of a degradation trend in Amazon Elastic Cloud 2 (“EC2”) performance provided to all registered consumers from a certain area, which may inform cloud optimization tools to pro-actively respond to the degradation and plan a change, rather than re-actively responding to a surge shortage caused by the degradation.

In existing systems, the goal may be the detection of complex situations. As cloud infrastructures evolve, businesses may have a new set of problems, which may be triggered by, for example, risk of configurations, security requirements, and compliance requirements. In this environment, the need to detect complex phenomena may be as important to business owners, as it is for IT managers. Designing optimized, generic situation-management systems may be difficult because the specific business situations and requirements often may be unknown. This difficulty may increase when businesses do not know what the next generation of products may be, what sensors and monitored data the next generation of products may provide, and which producers or consumers may be interested in such raw or derived events.

In the emerging business landscape, businesses may need a way in which they may offer new data elements to coordination systems, enable the construction of complex situations, and inform interested parties when certain situations are detected. Detecting these situations may be relevant not only to users of enterprise internal clouds, but also to all consumers of information (e.g., users of public, community, and private clouds).

Described herein are systems, methods, and computer program products stored on non-transitory, computer-readable media for offering complex event or situation detection and processing as a service. Described herein also is a revenue model based on selling this service, and monetizing reusable complex situational rules. The application of this system and method may not be limited to users of enterprise internal clouds, but may be offered to all consumers of data, through public, community and private clouds, while adhering to privacy and regulation rules.

Described herein are systems, methods, and computer program products stored on non-transitory, computer-readable media for a self-service cloud-based arena for IT-driven situational management. Embodiments described herein may facilitate, in an identical or standardized manner, the provisioning and consumption of event-based information to support a supply chain of integrated systems. Certain embodiments may comprise a fractal self-adaptive system for peer-based environments that are changing continuously. Certain embodiments may offer event-based information from a wide variety of sources to correlate IT events and other data or information provided by IT management monitoring tools and to notify business and IT consumers of situations or events detected. Consumers of information may subscribe to one or more of particular sources of event-based information and particular types of event-based information, such that the consumers may be notified when event-based information according to the consumers' preferences become available. Providers of information may determine what information to provide based on consumers' preferences, and the providers may place restrictions on the provided information according to the providers' preferences (e.g., restrictions on a number or characteristics of consumers, expiration times for the information, use restrictions, restrictions on further transfer).

An illustrative and non-limiting example of the provisioning and consumption of event-based information may be described with respect to the agriculture industry, for example. To monitor the viability of crops, certain farms may purchase sensors to record information (e.g., temperature, soil pH, humidity, wind speed). The information recorded by the sensors provides value to the certain farms because the certain farms may determine the best crops to plant and may establish procedures to tend to the crops (e.g., the certain farms may not water the crops when the information recorded by the sensors is used to predict an approaching rain storm). The information recorded by the sensors on the certain farms may also be of value to other farms located nearby, which may use information recorded by the sensors to predict local growing or weather conditions based on the information recorded by the sensors at the certain farms. Moreover, other consumers, such as agricultural futures traders may find the information recorded by the sensors valuable because the information recorded by the sensors may assist the agricultural futures traders in predicting crop yields and, subsequently, setting appropriate prices. Such consumers may aggregate information from sensors on a large number of farms to develop a robust data set and improve the predictive power of the data. Further, other consumers may aggregate the information recorded by the sensors and combine information recorded by the sensors with other available information, such as publicly-available atmospheric data, for example, to further improve the data and to tailor the data to the specific needs of certain consumers. The other consumers may ultimately utilize the aggregated data themselves, or the other consumers may sell the data to other parties, such as the certain farms or the agricultural futures traders. The present disclosure describes various systems, methods, and computer programs for facilitating (e.g., brokering, providing a clearinghouse function) the provisioning and consumption of such event-based information between various consumers and providers. The systems, methods, and computer programs of the present disclosure may be applicable to a broad range of fields, comprising, but not limited to, risk management, finance, business, weather, marketing, information technology, medicine, education, and research.

In existing systems, the goal may be the detection of the complex situations. The disclosure herein may be targeted towards offering the complex detection as a service and providing a revenue model based on selling this service, as well as offering reusable complex situational rules (e.g., this disclosure describes “analytics and event correlation as a service”). Such a service may use the complex situational rules or other analysis techniques to actively combine information from a plurality of providers to detect information that may be of interest to a consumer and offer the information to the consumer.

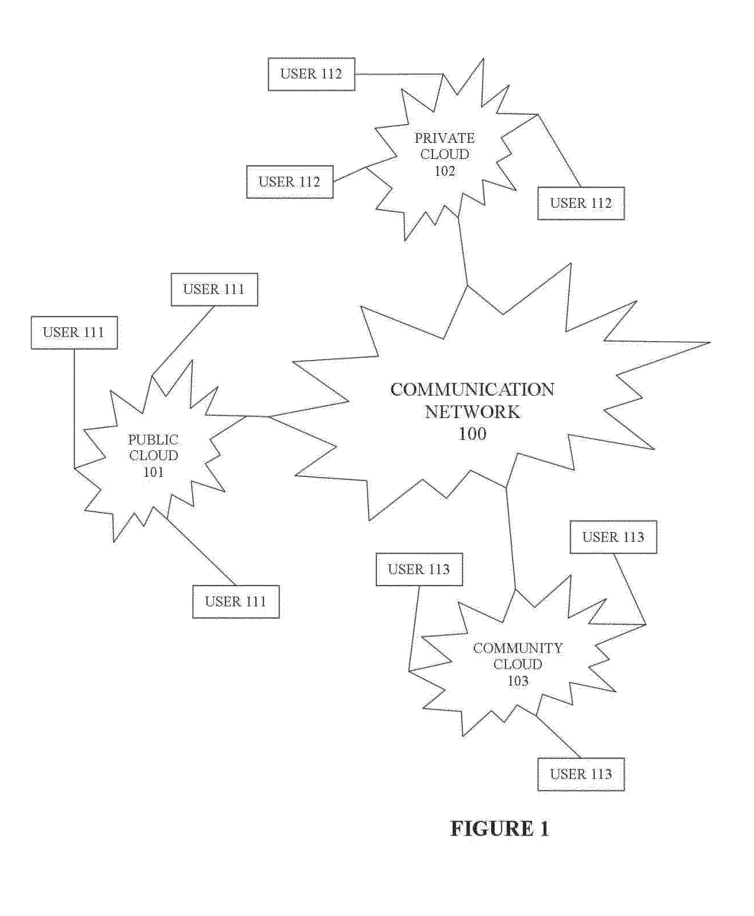

Referring now to FIGS. 1-3 of the drawings, embodiments of the present disclosure and its advantages may be understood, like numerals being used for like and corresponding parts of the various drawings and descriptions provided herein.

FIG. 1 depicts a communication network 100 comprised of public clouds 101, private clouds 102, and community clouds 103. A plurality of users 111 may connect to and access resources available in public clouds 101, a plurality of users 112 may connect to and access resources available in private clouds 102, and a plurality of users 113 may connect to and access resources available in community clouds 113. Each of clouds 101, 102, and 103 may be managed by an enterprise IT manager. The enterprise IT manager of each cloud 101, 102, and 103 may use communication network 100 to communicate with a plurality of enterprises and other clouds to collect, provide, and communicate information. In accordance with an embodiment, a platform for the brokering of situation management awareness may be used to collect and aggregate information from users 111, 112, and 113 and provide the aggregated information to subscribers desiring to obtain the aggregate information.

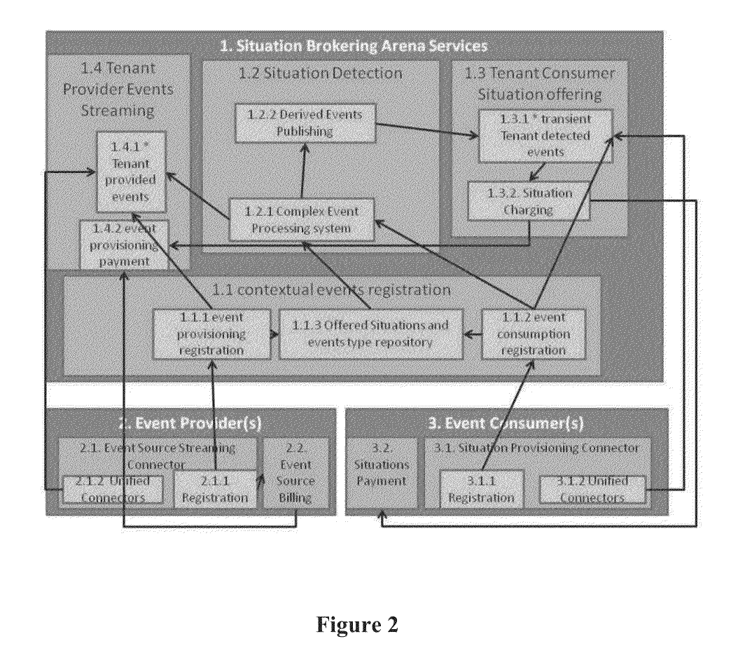

FIG. 2 depicts a process of brokering information on a platform for the brokering of situation management awareness implemented as computer-readable program code configured to instruct a processor to execute a plurality of process modules. The processes may comprise a Situation Brokering Service Arena module 1, an Event Provider module 2, and an Event Consumer module 3.

Situation Brokering Service Arena Module 1

Situation Brokering Service Arena module 1 may comprise a Contextual Event Registration sub-module 1.1, a Situation Detection sub-module 1.2, a Tenant Consumer Situation Offering sub-module 1.3, and a Tenant Provider Event Streaming sub-module 1.4.

Contextual Event Registration sub-module 1.1 may function as a module for combining one or more of provisioning information, registration information, and event information provided by information providers and subscription information (e.g., consumer registration information) provided by consumers. Information providers and consumers may comprise, but are not limited to, sensors, information storage devices and repositories, the Internet, private networks, and computing devices, and applications. Provisioning information may comprise, for example, information providing instructions for provisioning certain information (e.g., restrictions on or preferences for use or distribution). Registration information may comprise, for example, information about a provider (e.g., name, contact information, security information, preferences). Event information may comprise, but is not limited to, information regarding an event, activity, object, or status as determined by a sensor. Subscription information may comprise, for example, information about a consumer (e.g., name, contact information, security information, preferences) and other information about particular information or types of information that the consumer desires to receive.

Contextual Event Registration sub-module 1.1 may comprise an Event Provisioning Registration sub-module 1.1.1, which may receive and register one or more of event information and provisioning information from Event Provider module 2 (described later). In certain configurations, an Event Provisioning Registration sub-module 1.1.1 may receive information (e.g., meta-information) that has been pushed from an information provider. The information may comprise metrics collected from, for example, a sensor that have been manipulated, meta-data that describes the manipulation, quality information associated with the metrics, and semantic information associated with the metrics. In particular, Event Provisioning Registration sub-module 1.1.1 may register the event information and provisioning information in an information repository. Event Provisioning Registration sub-module 1.1.1 may impose restrictions or limitations on the event information received from Event Provider module 2 during registration or for use thereafter. The restrictions or limitations on the event information may be based on one or more of the provisioning information and characteristics of the event information. For example, Event Provisioning Registration sub-module 1.1.1 may require that a provider provide registration information to verify the provider's identity therewith before allowing the provider to provide event information to Situation Brokering Services Arena 1 through Event Provider module 2. Event Provisioning Registration sub-module 1.1.1 may verify the validity of a contract associated with one or more of the event information and the provider, and may register the event information only after verifying the one or more of the identity of the provider and the validity of the contract. Event Provisioning Registration sub-module 1.1.1 may impose other restrictions or limitations on the event information based on, for example, one or more of the relevance of the event information, the availability of the event information from other sources, the existence of identical or similar event information already registered by Event Provisioning Registration sub-module 1.1.1, restrictions placed on the event information by the provider or by a contractual agreement, the timeliness of the event information, and consumer demand for the event information. Event Provisioning Registration sub-module 1.1.1 may delete registered provisioning information and registered event information after a predetermined time to more efficiently allocate the resources of a system implementing the processes described herein.

Contextual Event Registration sub-module 1.1 may comprise an Event Consumption Registration sub-module 1.1.2, which may receive and register subscription information received from Event Consumer module 3. The registered subscription information may be based on one or more of the event information available in the repository, event information desired by the consumer that currently is not available in the repository, the restrictions placed on the event information by the provider, a price range of the event information, and a data confidence validity of the event information. For example, the data confidence validity of the event information may be derived from one or more of a time when the event information was measured or modified, an age of the event information, a source of the event information, and an accuracy of the event information.

Contextual Event Registration sub-module 1.1 may comprise an Offered Situations and Events Type Repository sub-module 1.1.3, which may receive the registered event information and the registered provisioning information from Event Provisioning Registration sub-module 1.1.1 and which may receive the registered subscription information from Event Consumption Registration sub-module 1.1.2. Offered Situations and Events Type Repository sub-module 1.1.3 may combine the received information and may create an active catalog of the received event information, the received provisioning information, and the received subscription information; and Offered Situations and Events Type Repository sub-module 1.1.3 may, periodically or continuously, update the repository as additional information is registered in Event Provisioning Registration sub-module 1.1.1 and Event Consumption Registration sub-module 1.1.2. Thus, the content of the repository may be based on the event information that currently is available for provisioning (e.g., event information or complex event information provided by one or more providers). Offered Situations and Events Type Repository sub-module 1.1.3 may update the repository by determining one or more of characteristics of event information available for provisioning, types of event information available for provisioning, a price of provisioning the available event information, a cost for consuming particular event information, and time-related characteristics of the available event information (e.g., age, staleness).

Situation Detection sub-module 1.2 may comprise a Complex Event Processing System sub-module 1.2.1. Complex Event Processing System sub-module 1.2.1 may function as a parallel computation engine, which may harvest event information from the event information repositories associated with one or more of the providers (e.g., Offered Situations and Events Type Repository sub-module 1.1.3), and which may compute (e.g., transform, correlate, apply logical operations to, statistically analyze, or perform another mathematical or logical process) derived complex event information (e.g., in the agricultural example: predicted rainfall) based on subscription information (e.g. in the agricultural example: subscription information for events associated with harvest yield) associated with one or more actual registered consumers (e.g., agriculture futures traders) received from one or more of Event Consumption Registration sub-module 1.1.2, Offered Situations and Events Type Repository sub-module 1.1.3, and Tenant Provided Events sub-module 1.4.1. When no consumers subscribe to particular event information, Complex Event Processing System sub-module 1.2.1 may not perform computations on the particular event information, even though the particular event information is available. In certain configurations, Complex Event Processing System sub-module 1.2.1 may process event information, such that the derived complex event information provides information desired by an information consumer yet is less complex and less cumbersome than the event information itself.

Situation Detection sub-module 1.2 may comprise a Derived Events Publishing sub-module 1.2.2. Derived Events Publishing sub-module 1.2.2 may receive the derived complex events computed by Complex Event Processing System sub-module 1.2.1 and may function to cache (e.g., cache in a memory such as memory 202) computed complex event information. For example, Complex Event Processing System sub-module 1.2.1 periodically may pull event information from all providers, may compute complex event information once or periodically for each consumer, and may store the computed complex event information using Derived Events Publishing sub-module 1.2.2.

Tenant Consumer Situation Offering sub-module 1.3 may offer computed complex event information to consumers based on the consumers' registered subscription information. For each registered consumer, Tenant Consumer Situation Offering sub-module 1.3 may store computed complex event information received from Derived Events Publishing sub-module 1.2.2 according to each consumer's particular subscription, such that each consumer actively may pull the computed complex event information from Tenant Consumer Situation Offering sub-module 1.3. For example, Tenant Consumer Situation Offering sub-module 1.3 may operate in a pay-per-consume mode. In the pay-per-consume mode, after each transaction (e.g., after complex event information is delivered to a consumer), Tenant Consumer Situation Offering sub-module 1.3 may initiate a billing process for the actual delivered information.

Tenant Consumer Situation Offering sub-module 1.3 may comprise a Transient Tenant Detected Events sub-module 1.3.1. Transient Tenant Detected Events sub-module 1.3.1 may function as a cache of complex event information corresponding to each registered consumers' subscription received from Derived Events Publishing sub-module 1.2.2. Transient Tenant Detected Events sub-module 1.3.1 may receive each consumer's subscription information from Event Consumption Registration sub-module 1.1.2 and create a cache of complex event information for each consumer, based on each consumer's subscription information. A consumer may connect to Transient Tenant Detected Events sub-module 1.3.1 using Unified Connector sub-module 3.1.2 (described later) and may pull information from the cache of complex event information corresponding to the consumer's subscription. In certain configurations, a processor executing processes corresponding to Unified Connector sub-module 3.1.2 may act as an information consumer. Transient Tenant Detected Events sub-module 1.3.1 periodically may remove information from the cache according to predetermined criteria (e.g., a contract between a party operating Situation Brokering Service Arena module 1 and the consumers), based on, for example, the age of the information, the quantity of the information, or the type of the information. In this manner, Transient Tenant Detected Events sub-module 1.3.1 may prevent an amount of the cached information from becoming so great that the cached information impedes the operation of Situation Brokering Service Arena module 1 (e.g., prevents over-flooding of a system implementing Situation Brokering Service Arena module 1).

Tenant Consumer Situation Offering sub-module 1.3 may comprise a Situation Charging sub-module 1.3.2. Situation Charging sub-module 1.3.2 may receive an acknowledgment from Transient Tenant Detected Events sub-module 1.3.1 when a consumer pulls complex event information from Transient Tenant Detected Events sub-module 1.3.1. After receiving the acknowledgement, Situation Charging sub-module 1.3.2 may initiate a billing process and charge the consumer that actively pulled the complex event information from Transient Tenant Detected Events sub-module 1.3.1 an amount based on the pulled complex event information. The amount charged also may be based on provisioning information provided by one or more providers of event information comprised in the complex event information. Situation Charging sub-module 1.3.2 may determine the amount as an aggregate of the cost for the event information comprised by the complex event information. In this manner, Situation Charging sub-module 1.3.2 may initiate a billing process for each consumer that actively pulls complex event information from Transient Tenant Detected Events sub-module 1.3.1. Situation Charging sub-module 1.3.2 may receive a payment for the charged amount from the consumer, via Situations Payment sub-module 3.2 (described later). After approval of a consumer's payment, Situation Charging sub-module 1.3.2 may transfer corresponding funds, via Event Source Billing sub-module 2.2 (described later), to the one or more providers of the event information comprised by the complex event information pulled by the consumer. Situation Charging sub-module 1.3.2 may determine an amount of the corresponding funds to be transferred to each of the one or more providers by determining the portion of the charged amount corresponding to each of the one or more providers' contribution (e.g., the event information provided by the provider that is comprised in the complex event information) to the complex event information and deducting a particular commission or fee. Alternatively or additionally, Situation Charging sub-module 1.3.2 may charge the commission or fee directly to the consumer.

Tenant Provider Event Streaming module 1.4 may comprise a Tenant Provided Events sub-module 1.4.1. Tenant Provided Events sub-module 1.4.1 may function as a cache for storing the streaming normalized (e.g., standardized, filtered, unified) events originating from a provider, via Unified Connectors sub-module 2.1.2 (described later) and Event Provisioning Registration sub-module 1.1.1. For example, after Event Provisioning Registration sub-module 1.1.1 receives and registers event information pushed or pulled from a provider, Registration sub-module 1.1.1 may initiate an instance of Tenant Provided Events sub-module 1.4.1, and Event Provisioning Registration sub-module 1.1.1 may provide a uniform resource locator (“URL”), which the provider may use to write or stream the event information to Tenant Provided Events sub-module 1.4.1. Tenant Provided Events sub-module 1.4.1 may provide received event information to Complex Event Processing System sub-module 1.2.1, which Complex Event Processing System sub-module 1.2.1 may use to compute complex event information.

Tenant Provider Event Streaming module 1.4 may comprise an Event Provisioning Payment sub-module 1.4.2. Event Provisioning Payment sub-module 1.4.2 may receive waiting-to-be-paid funds information for each provider (e.g., the amount of the corresponding funds to be transferred to each of the one or more providers determined by Situation Charging sub-module 1.3.2) from Situation Charging sub-module 1.3.2. Event Provisioning Payment sub-module 1.4.2 may manage payments to particular providers, based on the consumption of event information provided by the particular providers and certain commissions or fees (e.g., a commission or fee for brokering services provided by using Situation Brokering Service Arena module 1). For example, after every pulling action by a consumer, Situation Charging sub-module 1.3.2 may charge a Situation Payment sub-module 3.2 (described later), deduct a commission or fee from the amount collected and approved, and deliver the remainder of the amount collected and approved to Event Provisioning Payment sub-module 1.4.2. In certain embodiments, Event Provisioning Payment sub-module 1.4.2 may receive the charged amount (i.e., the amount charged to a consumer for pulling complex information) less a commission or fee. In such embodiments, Event Provisioning Payment sub-module 1.4.2 then may determine the amount of the corresponding funds to be transferred to each of the one or more providers by determining the portion of the charged amount less the commission or fee corresponding to each of the one or more providers' contribution (e.g., the event information provided by the provider that is comprised in the complex event information) to the complex event information, rather than Situation Charging sub-module 1.3.2. Event Provisioning Payment sub-module 1.4.2 subsequently transfers the corresponding funds to each of the one or more providers through Event Source Billing sub-module 2.2 (described later).

Event Provider Module 2

Each provider may use Event Provider module 2 as an interface for providing event information and provisioning information to Situation Brokering Service Arena 1. Event Provider module 2 may provide a similar interface for each provider of event information. For example, Event Provider module 2 may provide the same system or dedicated web pages, as well as the same on-premises appliances, to each provider of event information. Event Provider module 2 may comprise an Event Source Streaming Connector sub-module 2.1 and an Event Source Billing sub-module 2.2.

Event Source Streaming Connector sub-module 2.1 may comprise a Registration sub-module 2.1.1. Registration sub-module 2.1.1 may receive one or more of registration information and provisioning information from providers. Each of the registration information and the provisioning information may comprise, for example, identification information regarding the event information, contextual information regarding the event information, a requested cost for consuming the event information, other meta-information regarding the type of events or metrics provided, and contextual integrity information related to normalizing data semantics (e.g., language) of the event information, which may allow a Unified Connector sub-module 2.1.2 (described later) to normalize the event information, such that the published event information may have the same data structure and may be efficiently handled by the processes described herein and efficiently passed between different processing systems. For example, a provider of event information may login to Registration sub-module 2.1.1 and may provide structured meta-information regarding certain event information, may provide the requested cost for consuming the event information, and may sign a service level contract, which may be written using, for example, Insight or Oblicore terminology. Registration sub-module 2.1.1 may provide the registration information and provisioning information to Event Provisioning Registration sub-module 1.1.1.

Event Source Streaming Connector sub-module 2.1 may comprise Unified Connector sub-module 2.1.2. Unified Connector sub-module 2.1.2 may receive event information from a provider and may function as a connector, such that the provider may transfer the event information to Tenant Provided Events sub-module 1.4.1 for caching. Unified Connector sub-module 2.1.2 may normalize the event information using data passing normalization and may be similar to a process performed by a Catalyst connector (e.g., a technology for connecting component devices, such that the component devices may communicate information using a standardized data format). For example, a provider may provide event information to Event Source Streaming Connector sub-module 2.1, and the provider may write the event information from Unified Connector sub-module 2.1.2 to Tenant Provided Events sub-module 1.4.1 via the URL provided by Event Provisioning Registration sub-module 1.1.1. During this process, Unified Connector sub-module 2.1.2 may normalize the provided event information. In certain configurations, a processor executing processes corresponding to Unified Connector sub-module 2.1.2 may act as an information provider.

Event Source Billing sub-module 2.2 may receive the corresponding funds the from Event Provisioning Payment sub-module 1.4.2, and may transfer corresponding funds to the relevant providers.

Event Consumer Module 3

Event Consumer module 3 may provide an interface (e.g., a website), which each consumer of event information may use to access Situation Brokering Services Arena 1. Event Consumer module 3 may function as a consumer-dedicated system that may enable a consumer to retrieve event information as the event information appears on the interface. Event Consumer module 3 may comprise a Situation Provisioning Connector sub-module 3.1 and a Situations Payment sub-module 3.2.

Situation Provisioning Connector sub-module 3.1 may comprise a Registration sub-module 3.1.1. Registration sub-module 3.1.1 may be, for example, a software-as-a-service (“SaaS”) website, in which new and existing customers (e.g., consumers) may register for services from Situation Brokering Services Arena 1 and may provide subscription information, in which the consumers may select certain event information or certain complex event information, among other things. Each customer may agree to a purchasing contract for Situation Brokering Services Arena 1 to provide the certain event information or certain complex event information. Thus, Registration sub-module 3.1.1 may provide a self-service registration interface for customers to buy selected content and information. Consequently, Registration sub-module 3.1.1 may comprise a secure interface, which may allow customers to enter credit card information. Alternatively or additionally, Registration sub-module 3.1.1 may allow customers to provide approved purchase order information when the customers have arranged for ongoing billing or have an ongoing relationship with an operator or owner of Situation Brokering Services Arena 1. For example, each consumer may use Registration sub-module 3.1.1 to register for certain event information or certain complex event information (e.g., register for a subscription to the certain event information or certain complex event information), which Registration sub-module 3.1.1 may provide to Event Consumption Registration sub-module 1.1.2. During registration using Registration sub-module 3.1.1, each consumer may provide relevant commerce information and may establish “pay-per-use” contracts, as appropriate. Each consumer may select one or more of desired types, desired categories, and desired characteristics of event information and may set rules for consumption modes. In certain embodiments, each consumer's selection may be based on the contents made available by Events Type Repository sub-module 1.1.3.

Situation Provisioning Connector sub-module 3.1 may comprise a Unified Connector sub-module 3.1.2. Unified Connector sub-module 3.1.2 may connect with Transient Tenant Detected Events sub-module 1.3.1 to obtain complex event information from Situation Brokering Services Arena 1. Unified Connector sub-module 3.1.2 also may allow Event Consumer module 3 to transmit an acknowledgment to Tenant Consumer Situation Offering sub-module 1.3 indicating that Transient Tenant Detected Events sub-module 1.3.1 has delivered the complex event information to a consumer, so that Situation Charging sub-module 1.3.2 may initiate the billing process and charge the consumer. Unified Connector sub-module 3.1.2 may be a remote sub-module, which the consumer may write and operate remotely from Situation Brokering Services Arena 1. Alternatively, Unified Connector sub-module 3.1.2 may be a local sub-module, which may be stored and operated locally with Situation Brokering Services Arena 1. When Unified Connector sub-module 3.1.2 is a local sub-module, the consumer may be required to sign into an account and become approved for access management before obtaining the complex event information from Situation Brokering Services Arena 1. For example, each consumer periodically may pull event information from Transient Tenant Detected Events sub-module 1.3.1 using Unified Connector sub-module 3.1.2, and, after each pulling action, Situation Charging sub-module 1.3.2 may initiate a billing process by transmitting billing information to Situations Payment sub-module 3.2.

Situations Payment sub-module 3.2 may provide a consumer with billing information related to complex event information, which the consumer has pulled from Situation Brokering Services Arena 1. The billing information may comprise one or more of an amount charged, information regarding the complex event information delivered to or pulled by the consumer (e.g., a breakdown of the event information comprised therein and a corresponding cost breakdown), information describing the contents of the billing information, and other payment and procurement information. Situations Payment sub-module 3.2 may receive the billing information from Situation Charging sub-module 1.3.2.

Example Cases

The operation of the above-described embodiments may be better understood by referring to certain examples cases. Such example cases may comprise, for example, offering event information, situation consumption registration, event information streaming, and financial processing. The above-described example cases now are described, with reference to the above-described process modules.

Example Case: Offering Event Information

A provider of events may log into Registration sub-module 2.1.1 and may insert structured meta-information on an offered event, may insert the requested price of the information, and may sign a Service Level Contract, which may comprise Insight/Oblicore terminology. Event Provisioning Registration sub-module 1.1.1 may verify the identity of the provider and the validity of the contract. After approval, Event Provisioning Registration sub-module 1.1.1 may create a tenant database and information, as well as particular event information, may generate an instance of Tenant Provided Events sub-module 1.4.1, and may provide the URL for which the provider needs to write the event information (e.g., streaming event information) to Tenant Provided Events sub-module 1.4.1.

Example Case: Situation Consumption Registration

A consumer may register for needed event information, via the Registration sub-module 3.1.1, with the Event Consumption Registration sub-module 1.1.2, in which consumers may provide commerce information and establish “pay per use” contracts. The consumer may select the type of offered situation or event information and set rules for consumption modes, based on information provided in Situations and Events Type Repository sub-module 1.1.3. After registration, Event Consumption Registration sub-module 1.1.2 may create Transient Tenant Detected Events sub-module 1.3.1, which may contain the provided situations content (e.g., event information), in a timely manner, for the consumers to periodically pull using Unified Connector sub-module 3.1.2. After every pulling action, Situation Charging sub-module 1.3.2 may charge the Situations Payment sub-module 3.2, may remove commissions from the actual amount charged for services, and may deliver the remainder to Event Provisioning Payment sub-module 1.4.2, which periodically may transfer the funds to the relevant provider, via Event Source Billing sub-module 2.2.

Example Case: Event Information Streaming

The event provider may write event information from Unified Connector sub-module 2.1.2 to a dedicated URL, via Tenant Provided Events sub-module 1.4.1. Periodically, Complex Event Processing System sub-module 1.2.1 may pull events from all tenants, may compute the complex events once, and may store the computed complex events in Derived Events Publishing sub-module 1.2.2. According to the rules defined by registered consumers, the information may be copied for use by Transient Tenant Detected Events sub-module 1.3.1, until the consumer proactively requests the information (e.g., pulls the event information). After the consumer connects to the system via Unified Connector sub-module 3.1.2, the situation or event information may be delivered to the consumer, and Unified Connector sub-module 3.1.2 may provide an acknowledgement to Situation Charging sub-module 1.3.2, which may indicate that Situation Charging sub-module 1.3.2 may charge the consumer for the delivered situation or event information.

Example Case: Financial Processing

Periodically, Situation Charging sub-module 1.3.2 may charge for service, based on input from Situations Payment sub-module 3.2. After a consumer provides an approved payment, the payment information may be transferred to Event Provisioning Payment sub-module 1.4.2. The payment information may wait in Event Provisioning Payment sub-module 1.4.2 until payment to the provider of the consumed event information, via Event Source Billing sub-module 2.2.

### Modifications and Other Example Embodiments

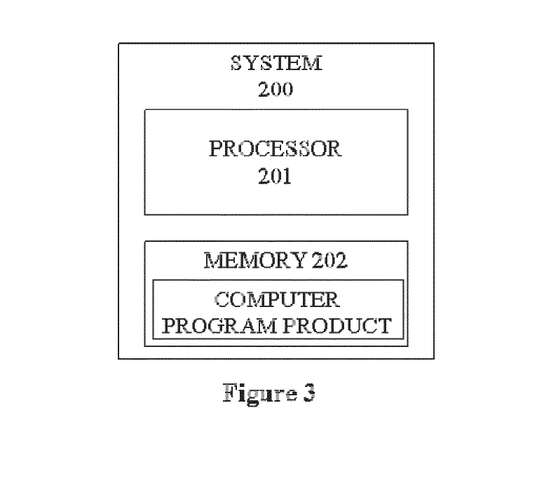

In certain embodiments, such as the example embodiment depicted in FIG. 3 the above-described process modules may be executed by a system (e.g., system 200) comprising one or more processors (e.g., processor 201) configured to perform functions corresponding to the above-described process modules and one or more non-transitory memories (e.g., memory 202) configured to store computer-readable instructions corresponding to the above-described process modules. Each of Situation Brokering Service Arena module 1, Event Provider module 2, and Event Consumer module 3 may be implemented locally on the same system, as depicted in FIG. 3, or on locally networked devices (not depicted). Alternatively, one or more of Situation Brokering Service Arena module 1, Event Provider module 2, and Event Consumer module 3 may be implemented remotely on one or more remote systems (not depicted), which may be controlled by one or more parties.

Certain embodiments may comprise a method implementing one or more functions of the above-described process modules. A party may implement one or more processes of the above-described method on local systems for providers and consumers of event information. In some embodiments, the party may offer one or more functions of the above-described process modules to providers and consumers in the form of software-as-a-service, in which the party charges a commission or fee to one or more of the providers and the consumers.

In certain embodiments, the above-described process modules may comprise a Catalyst module, which may facilitate multi-system integration, and a Spectrum Assurance Management module, which may provide event management, that may be designed for data passing, for federated databases, and for normalizing events into a common notation and semantics, known as a Unified Service Model. The present disclosure supports use cases that are driven by certain products' integration needs.

In certain embodiments, consumers may also be providers. When consumers also are providers, features of Event Provider module 2 and Event Consumer module 3 may be combined together to create a single interface for consumers and providers. For example, one or more of Situation Charging sub-module 1.3.2 and Event Provisioning Payment sub-module 1.4.2 may maintain accounts for each registered user (e.g., registered consumers and registered providers) of Situation Brokering Services Arena 1. The one or more of Situation Charging sub-module 1.3.2 and Event Provisioning Payment sub-module 1.4.2 may debit a user's account appropriately when the user pulls complex event information from Situation Brokering Services Arena 1 and may credit the user's account appropriately when another user consumes event information provided by the user. In some cases, consumers that also are providers may be aggregators. Such aggregators may pull complex event information from Situation Brokering Services Arena 1, modify the pulled complex event information, and provide the modified complex event information to Situation Brokering Services Arena 1 for use by other consumers.

Example cases for “using” the above-described process modules, from a consumer point of view, now are described. Such cases are merely examples, and the breadth of this disclosure is not limited to these examples or situations.

In an example, a Security IT officer may desire to automatically assign and remove access permits to underlying servers under management, for a specific composite application. Separation of duties may be cardinal to the change of the infrastructure in order to maintain the management aspects; however, allowing all administrators to access the entire infrastructure may hinder this separation. A change in the structure, for certain areas, for certain business applications (e.g., the complex situation), may notify the security systems (e.g., identity management) to adjust the credentials, which may prevent orphan accounts, or over provisioned access, and which may create a continuous integrity of the system, as well as on-going audit capabilities.

In another example, a business owner of a procurement system may desire to be informed about excessive use of payment transactions, and, consequently, may desire to halt the processing pending further examinations for possible theft or fraud.

In yet another example, a data privacy and compliance office may desire to be informed about changes in location of specific data within specific databases. Monitoring transactions from such databases, as well as the location where data resides, may an important derivative to the data privacy and compliance office, and such information may trigger a criminal investigation.

The flowcharts and block diagrams in FIGS. 1-3 illustrate the architecture, functionality, and operation of possible implementations of systems, methods and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application and to enable others of ordinary skill in the art to understand the disclosure with various modifications as are suited to the particular use contemplated.

1. A method for accommodating provisioning and consumption of information, the method comprising:
receiving information from an information provider, the information comprising metrics collected from a sensor that have been manipulated, meta-data that describes the manipulation, quality information associated with the metrics, and semantic information associated with the metrics;
transforming and correlating the information received from the information provider, such that the information becomes transformed and correlated information;
storing the transformed and correlated information in a memory device;
transmitting the transformed and correlated information to a registered information consumer;
establishing a first account for the information provider pursuant to the information received from the information provider;
establishing a second account for the registered information consumer pursuant to the transformed and correlated information transmitted to the registered information consumer; and
applying a payment policy based on the first account and the second account.

2. The method of claim 1 further comprising:
receiving subscription information comprising a request for information associated with a particular event from the registered information consumer,
wherein transmitting the transformed and correlated information to the registered information consumer comprises transmitting the transformed and correlated information to the registered information consumer based on the subscription information received from the registered information consumer.

3. The method of claim 1 further comprising:
receiving subscription information comprising a request for information associated with a particular event from the registered information consumer,
wherein transforming and correlating the information received from the information provider comprises transforming and correlating the information received from the information provider based on the subscription information received from the registered information consumer.

4. The method of claim 3 further comprising:
storing the transformed and correlated information in a cache within the memory device, the cache associated with the registered information consumer; and
charging the registered information consumer for the transformed and correlated information according to the payment policy after transmitting the transformed and correlated information to the registered information consumer,
wherein transmitting the transformed and correlated information to the registered information consumer comprises transmitting the transformed and correlated information stored in the cache to the registered information consumer when the registered information consumer performs an action to pull the transformed and correlated information stored in the cache.

5. The method of claim 1, wherein applying the payment policy based on the first account and the second account comprises:
charging the registered information consumer an amount based on the transformed and correlated information transmitted to the registered information consumer;
determining a fee to be deducted from the amount charged to the registered information consumer;
retaining the fee deducted from the amount charged to the registered information consumer; and
crediting the information provider an amount equal to the amount charged to the registered information consumer less the fee deducted from the amount charged to the registered information consumer.

6. The method of claim 5 further comprising:
receiving provisioning information from the information provider,
wherein the amount charged to the registered information consumer is based on the provisioning information received from the information provider, and
wherein the provisioning information comprises:
a cost for consuming the transformed and correlated information;
a restriction regarding the use of the transformed and correlated information; and
a restriction on the distribution of the transformed and correlated information.

7. The method of claim 1,
wherein transforming and correlating the information received from the information provider comprises transforming and correlating the information received from the information provider, such that the transformed and correlated information comprises information from a particular information provider,
wherein establishing the first account pursuant to the information received from the information provider further comprises establishing the first account, such that the first account comprises credit entries for information from the particular information provider comprised in the transformed and correlated information transmitted to the registered information consumer,
wherein establishing the second account pursuant to the transformed and correlated information transmitted to the registered information consumer further comprises establishing the second account, such that the second account comprises debit entries for the transformed and correlated information transmitted to the particular information provider,
wherein the method further comprises reconciling the first account and the second account when the particular information provider is both an information provider and an information consumer, and
wherein applying the payment policy based on the first account and the second account further comprises determining a payment amount associated with the particular information provider and based on the reconciling of the first account and the second account.

8. The method of claim 1,
wherein the information provider comprises a plurality of information providers, and
wherein the registered information consumer comprises a plurality of information consumers.

9. A system for accommodating provisioning and consumption of information, the system comprising:
a processor; and
a memory configured to store computer-readable instructions thereon, the computer-readable instructions configured to instruct the processor to operate as:
a first receiving device configured to receive information from an information provider, the information comprising metrics collected from a sensor that have been manipulated, meta-data that describes the manipulation, quality information associated with the metrics, and semantic information associated with the metrics;
a transforming and correlating device configured to transform and correlate the information received from the information provider, such that the information becomes transformed and correlated information;
a transmitting device configured to transmit the transformed and correlated information to a registered information consumer; and
an accounting device configured to:
establish a first account for the information provider pursuant to the information received from the information provider;
establish a second account for the registered information consumer pursuant to the transformed and correlated information provided to the registered information consumer; and
apply a payment policy based on the first account and the second account.

10. The system of claim 9,
wherein the computer-readable instructions are configured to instruct the processor to operate as a second receiving device configured to receive subscription information comprising a request for information associated with a particular event from the registered information consumer, and
wherein the transmitting device is configured to transmit the transformed and correlated information to the registered information consumer based on the subscription information received from the registered information consumer.

11. The system of claim 9,
wherein the computer-readable instructions are configured to instruct the processor to operate as a second receiving device configured to receive subscription information comprising a request for information associated with a particular event from the registered information consumer, and
wherein the transforming and correlating device is configured to transform and correlate the information received from the information provider based on subscription information received from the registered information consumer.

12. The system of claim 11,
wherein the computer-readable instructions are configured to instruct the processor to operate as a storing device configured to store the transformed and correlated information in a cache associated with the registered information consumer,
wherein the transmitting device is configured to transmit the transformed and correlated information stored in the cache to the registered information consumer when the registered information consumer performs an action to pull the transformed and correlated information stored in the cache, and
wherein the accounting device is configured to charge the registered information consumer for the transformed and correlated information according to the payment policy after transmitting the transformed and correlated information stored in the cache to the registered information consumer.

13. The system of claim 9, wherein the accounting device is configured to:
charge the registered information consumer an amount based on the transformed and correlated information transmitted to the registered information consumer;
determine a fee to be deducted from the amount charged to the registered information consumer;
retain the fee deducted from the amount charged to the registered information consumer; and
credit the information provider an amount equal to the amount charged to the registered information consumer less the fee deducted from the amount charged to the registered information consumer.

14. The system of claim 13,
wherein the first receiving device is configured to receive provisioning information from the information provider, and
wherein the amount charged to the registered information consumer is based on the provisioning information received from the information provider, and
wherein the provisioning information comprises:
a cost for consuming the transformed and correlated information;
a restriction regarding the use of the transformed and correlated information; and
a restriction on the distribution of the transformed and correlated information.

15. The system of claim 9,
wherein the transforming and correlating device is configured to transform the information received from the information provider, such that the transformed and correlated information comprises information from a particular information provider,
wherein the accounting device is configured to establish the first account, such that the first account comprises credit entries for the information from the particular information provider that is comprised in the transformed and correlated information transmitted to the registered information consumer,
wherein the accounting device is configured to establish the second account, such that the second account comprises debit entries for the transformed and correlated information transmitted to the particular information provider,
wherein the accounting device is configured to reconcile the first account and the second account when the particular information provider is both an information provider and an information consumer, and
wherein the accounting device is configured to determine a payment amount associated with the particular information provider and based on the reconciling of the first account and the second account.

16. The system of claim 9,
wherein the information provider comprises a plurality of information providers, and
wherein the registered information consumer comprises a plurality of information consumers.

17. A computer program product comprising:
a non-transitory computer-readable storage medium having computer-readable program code embodied therewith, the computer-readable program code comprising:
computer-readable program code configured to instruct a processor to receive information from an information provider, the information comprising metrics collected from a sensor that have been manipulated, meta-data that describes the manipulation, quality information associated with the metrics, and semantic information associated with the metrics;
computer-readable program code configured to instruct a processor to transform and correlate the information received from the information provider, such that the information becomes transformed and correlated information;
computer-readable program code configured to instruct a processor to transmit the transformed and correlated information to a registered information consumer;
computer-readable program code configured to instruct a processor to establish a first account for the information provider pursuant to the information received from the information provider;
computer-readable program code configured to instruct a processor to establish a second account for the registered information consumer pursuant to the transformed and correlated information transmitted to the registered information consumer; and
computer-readable program code configured to instruct a processor to apply a payment policy based on the first account and the second account.

18. The computer program product of claim 17,
wherein the computer-readable program code further comprises computer-readable program code configured to instruct a processor to receive subscription information comprising a request for information associated with a particular event from the registered information consumer,
wherein the computer-readable program code configured to instruct a processor to transmit the transformed and correlated information to the registered information consumer comprises:
computer-readable program code configured to instruct a processor to transmit the transformed and correlated information to the registered information consumer based on the subscription information received from the registered information consumer.

19. The computer program product of claim 17,
wherein the computer-readable program code further comprises computer-readable program code configured to instruct a processor to receive subscription information comprising a request for information associated with a particular event from the registered information consumer; and
wherein the computer-readable program code configured to instruct a processor to transform and correlate the information received from the information provider comprises:
computer-readable program code configured to instruct a processor to transform and correlate the information received from the information provider based on the subscription information received from the registered information consumer.

20. The computer program product of claim 19,
wherein the computer-readable program code further comprises computer-readable program code configured to instruct a processor to store the transformed and correlated information in a cache associated with the registered information consumer; and
wherein the computer-readable program code further comprises computer-readable program code configured to instruct a processor to charge the registered information consumer for the transformed and correlated information according to the payment policy after transmitting the transformed and correlated information to the registered information consumer,
wherein the computer-readable program code configured to instruct a processor to transmit the transformed and correlated information to the registered information consumer comprises:
computer-readable program code configured to instruct a processor to transmit the transformed and correlated information stored in the cache to the registered information consumer when the registered information consumer performs an action to pull the transformed and correlated information stored in the cache.

21. The computer program product of claim 17, wherein the computer-readable program code configured to instruct a processor to apply the payment policy based on the first account and the second account comprises:
computer-readable program code configured to instruct a processor to charge the registered information consumer an amount based on the transformed and correlated information transmitted to the registered information consumer;
computer-readable program code configured to instruct a processor to determine a fee to be deducted from the amount charged to the registered information consumer;
computer-readable program code configured to retain the fee deducted from the amount charged to the registered information consumer; and
computer-readable program code configured to instruct a processor to credit the information provider an amount equal to the amount charged to the registered information consumer less the fee deducted from the amount charged to the registered information consumer.

22. The computer program product of claim 21,
wherein the computer-readable program code further comprises computer-readable program code configured to receive provisioning information from the information provider, and
wherein computer-readable program code configured to instruct a processor to charge the registered information consumer the amount based on the transformed and correlated information transmitted to the registered information consumer comprises:
computer-readable program code configured to instruct a processor to charge the registered information consumer the amount based on the provisioning information received from the information provider, and
wherein the provisioning information comprises:
a cost for consuming the transformed and correlated information;
a restriction regarding the use of the transformed and correlated information; and
a restriction on the distribution of the transformed and correlated information.

23. The computer program product of claim 17,
wherein the computer-readable program code configured to instruct a processor to transform and correlate the information received from the information provider comprises:
computer-readable program code configured to instruct a processor to transform and correlate the information received from the information provider, such that the transformed and correlated information comprises information from a particular information provider,
wherein the computer-readable program code configured to instruct a processor to establish the first account pursuant to the information received from the information provider further comprises:
computer-readable program code configured to instruct a processor to establish the first account, such that the first account comprises credit entries for information from the particular information provider comprised in the transformed and correlated information transmitted to the registered information consumer,
wherein computer-readable program code configured to instruct a processor to establish the second account pursuant to the transformed and correlated information transmitted to the registered information consumer further comprises:
computer-readable program code configured to instruct a processor to establish the second account, such that the second account comprises debit entries for the transformed and correlated information transmitted to the particular information provider,
wherein the computer-readable program code configured to instruct a processor to apply the payment policy based on the first account and the second account comprises:
computer-readable program code configured to instruct a processor to reconcile the first account and the second account when the particular information provider is both an information provider and an information consumer, and
computer-readable program code configured to instruct a processor to determine a payment amount associated with the particular information provider and based on the reconciling of the first account and the second account.

24. The computer program product of claim 17,
wherein the information provider comprises a plurality of information providers, and
wherein the registered information consumer comprises a plurality of information consumers.
